(19) United States
(12) Patent Application Publication
(10) Pub. No.: US 2026/0259810 A1
(43) Pub. Date: Sep. 3, 2026

(54) SYSTEMS AND METHODS FOR CONTENT EVALUATION

(71) Applicant: Protiviti Inc., Menlo Park, CA (US)

(72) Inventors: Dominique Patricia DiFalco, New York City, NY (US); Alexander Weishaupl-Vartuli, Pelham, NY (US); Julia Anne Berchtold, New York City, NY (US)

(73) Assignee: Protiviti Inc., Menlo Park, CA (US)

(21) Appl. No.: 19/446,343

(22) Filed: Jan. 12, 2026

Related U.S. Application Data
(60) Provisional application No. 63/766,320, filed on Mar. 3, 2025.

(51) Int. Cl. G06F 11/34; G06F 16/3329

(52) U.S. Cl. CPC G06F 11/3414; G06F 16/33295

(57) ABSTRACT

Systems and methods for content evaluation are provided. A system can receive content items and a selection of criteria categories to evaluate the content items. The system can dynamically construct, for each of the criteria categories, a prompt to determine a quantitative score for conformance of each of the plurality of content items with each of the plurality of criteria categories. The system can cause an LLM to execute the prompts to generate quantitative scores and qualitative explanations for the quantitative scores for the conformance of the content items against a corresponding one of the criteria categories. The data processing system can present a recommendation including at least an aggregate qualitative explanation and quantitative scores of at least a subset of the content items.

### CROSS-REFERENCE TO RELATED APPLICATION

This application claims the benefit of, and priority to United States Provisional Patent Application No. 63/766,320, filed March 3, 2025, which is incorporated by reference in its entirety for all purposes.

### FIELD OF DISCLOSURE

The present disclosure is generally related to content evaluation, including but not limited to, determining an alignment between content items and one or more criteria categories.

### BACKGROUND

Enterprises can maintain various content items, which can include various digital assets. The content items can vary in their adherence to various criteria. For example, the content items can be provided with greater or less legibility, clarity, or relevance for one or more audiences. Digital marketing and website optimization faces several technical challenges that impact its effectiveness. One significant issue is the integration of various functionalities into a cohesive strategy. This often requires manual interpretation and application of insights, which can be time-consuming and error-prone. The need for continuous monitoring and updating of digital strategies to keep up with evolving market trends and consumer behaviors adds to the complexity. Additionally, scalability is a major challenge, as businesses must ensure consistent and efficient operations across different platforms and channels. The reliance on multiple specialized tools can lead to fragmented data and insights, making it difficult to obtain a holistic view of performance. These technical problems result in inefficiencies, increased workload, and potential inaccuracies in data interpretation.

### SUMMARY

An enterprise can include various content items. For example, the content items can include textual content, images, video files, and so forth. The content items can be aggregated according to a digital asset management system (DAM), content management system (CMS), or other data store, which can include an in situ data store, such as a website. The content items can exhibit varying alignment to one or more criteria categories. For example, the criteria categories can include legibility or clarity, accuracy, tone, relevance to one or more audiences, alignment to a brand identity, and so forth. Alignment with at least some of the criteria categories can vary between audiences or brands. For example, language, colors, or other content closely aligned with a modernist or experimental focus can lack alignment with more classic or stately criteria.

Technical solutions of the present disclosure can generate, for each of various content items, prompts to determine quantitative scores and qualitative explanations for alignment to one or more of the criteria categories. For example, the prompts can be generated for provision to a generative artificial intelligence model, such as a large language model (LLM), such that the LLM can generate the outputs of the quantitative score and qualitative explanations. Moreover, the quantitative score and qualitative explanations for the various content items can be aggregated to determine aggregate scores for various content items.

Embodiments of the present disclosure address specific technical challenges in large scale, multimodal content evaluation including ingesting heterogeneous data from multiple enterprise repositories, automatically constructing criteria specific prompts, managing distributed LLM execution, and performing hierarchical, prominence sensitive aggregation. Accordingly, various implementations of a data processing system of the present disclosure can operate to transform raw content items and metadata into structures for automated digital asset governance workflows. Further, implementations of the present disclosure can iterate according to available computational resources to provide scalability across various computational systems.

The data processing can generate an output of a graphical user interface (GUI). The GUI can display individual and aggregated numerical scores along with corresponding explanatory qualitative explanations. The GUI can include control elements actuatable to dynamically filter or reorganize the presented results in response to user selected parameters such as threshold scores, metadata ranges, or hierarchical positions within a repository. The interface can incorporate automated ranking, grouping, and highlighting logic based on machine generated indicators to present content deviating from criteria categories, as can expedite their review or adjustment.

In some aspects, the techniques described herein relate to a system, including one or more processors coupled with memory, the system including: an ingestion engine configured to receive, from a data repository, a plurality of content items; an interface configured to receive a selection of a plurality of criteria categories to evaluate the plurality of content items and evaluation criteria data for each of the plurality of criteria categories; a prompt generator configured to dynamically construct, for each of the plurality of criteria categories, a prompt to determine a quantitative score for conformance of each of the plurality of content items with each of the plurality of criteria categories, the prompt configured to instruct a large language model (LLM) to compare the evaluation criteria data against each of the plurality of content items; an evaluation agent configured to receive the prompts from the prompt generator and cause the LLM to execute the prompts to generate, for each of the plurality of content items, the quantitative score for the conformance and a qualitative explanation for the quantitative score for the conformance of the plurality of content items against a corresponding one of the plurality of criteria categories; an aggregator configured to determine, using the quantitative score of each of the plurality of content items, an aggregate quantitative score for each of the plurality of criteria categories and an aggregate qualitative explanation for each of the aggregate quantitative scores; and a user interface configured to present a recommendation including at least the aggregate qualitative explanation and a plurality of quantitative scores of at least a subset of the plurality of content items.

In some aspects, the techniques described herein relate to a system, wherein: the plurality of content items include a plurality of content types, including text, images, and animations; the LLM is a multi-modal LLM; and the evaluation criteria data include separate instructions according to the plurality of content types.

In some aspects, the techniques described herein relate to a system, wherein: the data repository includes an indication of a prominence of one or more of the plurality of content items relative to other of the plurality of content items; the aggregate quantitative score is weighted based on the prominence; and the aggregate qualitative explanation is weighted based on the prominence.

In some aspects, the techniques described herein relate to a system, wherein the indication of the prominence is based on: a number of accesses of the one or more of the plurality of content items; and a location of the one or more of the plurality of content items.

In some aspects, the techniques described herein relate to a system, wherein the aggregate quantitative score and the aggregate qualitative explanation are weighted based on a content type, the content type including text, images, and animations.

In some aspects, the techniques described herein relate to a system, wherein the data repository is a content management service for a website.

In some aspects, the techniques described herein relate to a system, wherein the user interface is configured to present the quantitative scores for content items of a webpage of the website in response to receiving a selection of the webpage.

In some aspects, the techniques described herein relate to a system, wherein the user interface is configured to present, in response to a selection of a node within a hierarchical data structure: the quantitative scores associated with the node; and an aggregate quantitative score for the node.

In some aspects, the techniques described herein relate to a method, including: receiving, by one or more processors coupled with memory, a plurality of content items from a data repository; receiving, by the one or more processors, a selection of a plurality of criteria categories to evaluate the plurality of content items and evaluation criteria data for each of the plurality of criteria categories; dynamically constructing, by the one or more processors for each of the plurality of criteria categories, a prompt configured to determine a quantitative score for conformance of each of the plurality of content items with each of the plurality of criteria categories, the prompt configured to instruct a large language model (LLM) to compare the evaluation criteria data against each of the plurality of content items; causing the LLM to execute the prompts to generate, for each of the plurality of content items, the quantitative score for the conformance and a qualitative explanation for the quantitative score for the conformance of the plurality of content items against a corresponding one of the plurality of criteria categories; determining, by the one or more processors using the quantitative score of each of the plurality of content items, an aggregate quantitative score for each of the plurality of criteria categories and an aggregate qualitative explanation for each of the aggregate quantitative scores; and presenting via a user interface, by the one or more processors, a recommendation including at least the aggregate qualitative explanation and a plurality of quantitative scores of at least a subset of the plurality of content items.

In some aspects, the techniques described herein relate to a method, wherein: the LLM is a multi-modal LLM; and the evaluation criteria data include non-textual exemplar data.

In some aspects, the techniques described herein relate to a method, wherein: the data repository includes an indication of a prominence of one or more of the plurality of content items; the aggregate quantitative score is weighted based on the prominence; or the aggregate qualitative explanation is weighted based on the prominence.

In some aspects, the techniques described herein relate to a method, wherein the indication of the prominence is based on: a number of accesses of the one or more of the plurality of content items; or a location of the one or more of the plurality of content items.

In some aspects, the techniques described herein relate to a method, wherein the aggregate quantitative score or the aggregate qualitative explanation are weighted based on a content type, the content type including text, images, or animations.

In some aspects, the techniques described herein relate to a method, wherein the data repository is a content management service for a website.

In some aspects, the techniques described herein relate to a method, wherein the user interface is configured to present the quantitative scores for content items of a webpage of the website in response to receiving a selection of the webpage.

In some aspects, the techniques described herein relate to a method, wherein the user interface is configured to present, in response to a selection of a node within a hierarchical data structure: the quantitative scores associated with the node; and an aggregate quantitative score for the node.

In some aspects, the techniques described herein relate to a computer-readable memory including instructions that, upon execution by one or more processors, cause the one or more processors to: receive, from a data repository, a plurality of content items; receive a selection of a plurality of criteria categories to evaluate the plurality of content items and evaluation criteria data for each of the plurality of criteria categories; dynamically construct, for each of the plurality of criteria categories, a prompt to determine a quantitative score for conformance of each of the plurality of content items with each of the plurality of criteria categories, the prompt configured to instruct a large language model (LLM) to compare the evaluation criteria data against each of the plurality of content items; cause the LLM to execute the prompts to generate, for each of the plurality of content items, the quantitative score for the conformance and a qualitative explanation for the quantitative score for the conformance of the plurality of content items against a corresponding one of the plurality of criteria categories; determine, using the quantitative score of each of the plurality of content items, an aggregate quantitative score for each of the plurality of criteria categories and an aggregate qualitative explanation for each of the aggregate quantitative scores; and present, via a user interface, a recommendation including at least the aggregate qualitative explanation and a plurality of quantitative scores of at least a subset of the plurality of content items.

In some aspects, the techniques described herein relate to a computer-readable memory, wherein the evaluation criteria data include exemplar data.

In some aspects, the techniques described herein relate to a computer-readable memory, wherein the exemplar data includes textual, image, and video data.

In some aspects, the techniques described herein relate to a computer-readable memory, wherein the aggregate quantitative score and the aggregate qualitative explanation are weighted based on a weighting assigned to each of the data content items.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A illustrates an example block diagram depicting a computing device, in accordance with one or more embodiments.

FIG. 1B illustrates an example block diagram depicting a computing environment comprising a client device in communication with cloud service providers, in accordance with one or more embodiments.

FIG. 2A illustrates an example block diagram depicting a system using supervised learning, in accordance with one or more embodiments.

FIG. 2B illustrates an example block diagram depicting a simplified neural network model, in accordance with one or more embodiments.

FIG. 3 illustrates an example of a data processing system, in accordance with one or more embodiments.

FIG. 4A and 4B illustrate an example of a flow diagram of a method for content evaluation, in accordance with one or more embodiments.

FIG. 5 illustrates examples of criteria categories, in accordance with one or more embodiments.

FIG. 6 illustrates an example graphical user interface for presenting information related to the content items, in accordance with one or more embodiments.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

For purposes of reading the description of the various embodiments below, the following descriptions of the sections of the specification and their respective contents may be helpful:

Section A describes a computing environment and network environment that can be useful for practicing embodiments described herein.

Section B describes an artificial intelligence environment that can be useful for practicing embodiments described herein .

Section C described embodiments of the present solution directed to an AI based content evaluation tool.

### A.Computing and Network Environment

Prior to discussing the specifics of embodiments of dynamic management of adaptive stock-keeping units for procedure-based inventory, it may be helpful to discuss the computing environments in which such embodiments may be deployed.

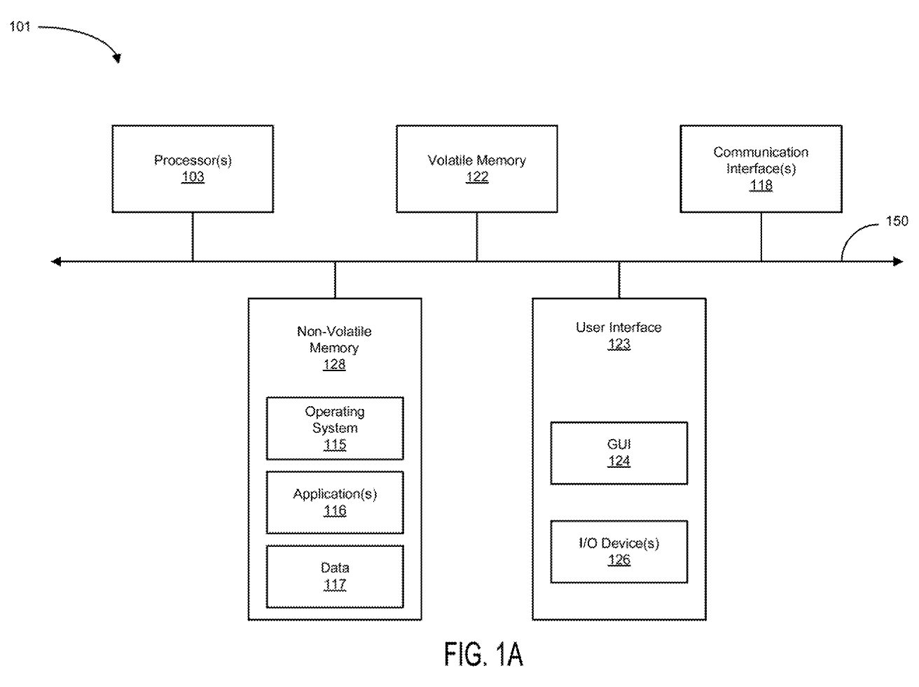

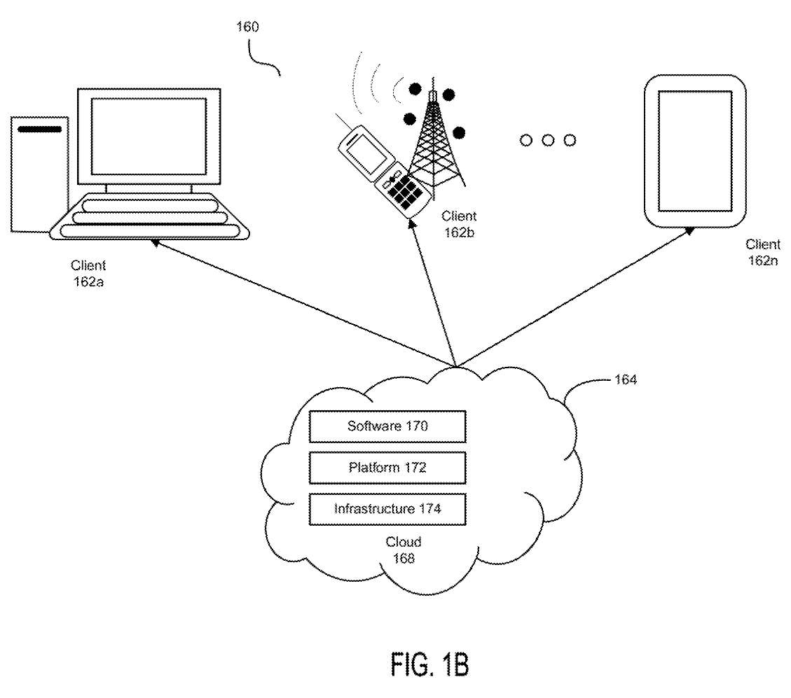

As shown in FIG. 1A, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 162 with one or more resources provided by a network environment. The computing environment 162 may include one or more clients 162a-162n, in communication with a cloud 168 over one or more networks 164. Clients 162 may include, e.g., thick clients, thin clients, and zero clients. The cloud 168 may include back end platforms, e.g., servers 106, storage, server farms or data centers. The clients 162 can be the same as or substantially similar to computer 101 of FIG. 1A.

The users or clients 162 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 168 may be public, private, or hybrid. Public clouds 168 may include public servers that are maintained by third parties to the clients 162 or the owners of the clients 162. The servers may be located off-site in remote geographical locations as disclosed above or otherwise. Public clouds 168 may be connected to the servers over a public network 164. Private clouds 168 may include private servers that are physically maintained by clients 162 or owners of clients 162. Private clouds 168 may be connected to the servers over a private network 164. Hybrid clouds 168 may include both the private and public networks 164 and servers.

The cloud 168 may include back end platforms, e.g., servers, storage, server farms or data centers. For example, the cloud 168 can include or correspond to a server or system remote from one or more clients 162 to provide third party control over a pool of shared services and resources. The computing environment 160 can provide resource pooling to serve multiple users via clients 162 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 162. The computing environment 160 can provide an elasticity to dynamically scale out or scale in responsive to different demands from one or more clients 162. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 168 may also include a cloud based delivery, e.g. Software as a Service (SaaS) 170, Platform as a Service (PaaS) 172, and Infrastructure as a Service (IaaS) 174. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 162 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 162 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 162 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 162 may also access SaaS resources through smartphone or tablet applications, including, e.g., Salesforce Sales Cloud, or Google Drive app. Clients 162 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Artificial Intelligence Environment

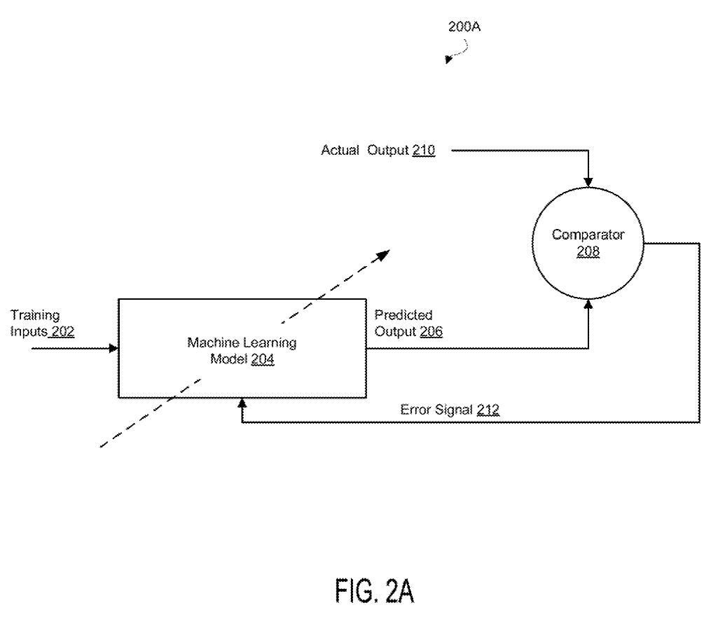

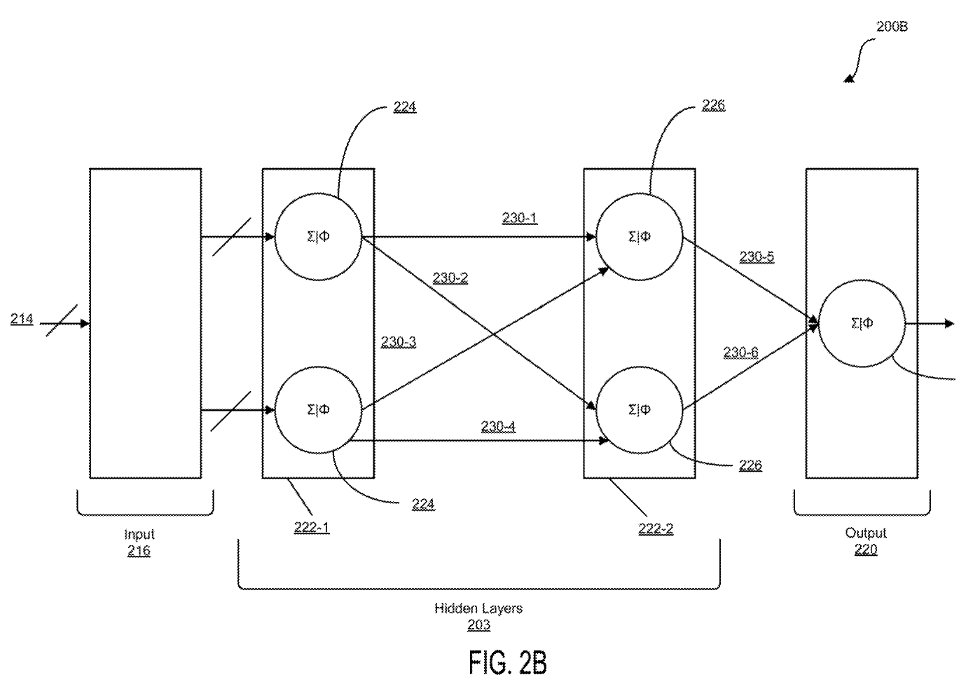

Referring to FIG. 2A, an embodiment of an artificial intelligence environment 200A is depicted. The artificial intelligence environment 200A may incorporate various machine learning models to process data, identify patterns, and generate predictions or decisions. By way of example, machine learning models can comprise supervised learning models, clustering models, neural network models, reinforcement learning models, decision trees, support-vector machines, Bayesian networks, Gaussian processes, genetic algorithms models, any other models that can be used by one or more machine learning algorithms, any other models that can learn from data (e.g., training data) to perform tasks without explicit instructions, or various combinations thereof. The neural network models can comprise, for example and without limitation, artificial neural networks (ANNs), deep neural networks (DNNs), deep belief networks (DBNs), one or more language models, large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), any other models that can learn patterns and make predictions or decisions, or various combinations thereof.

The machine learning models can be configured, learned, or trained using various learning or training operations, such as unsupervised learning, weakly supervised learning, semi-supervised learning, supervised learning, or any other learning or training operations that can learn from data (e.g., training data) and generalize to unseen data, or various combinations thereof. For example, parameters of nodes of a neural network model, such as weights, biases, and/or thresholds, can be configured, learned, or trained using various learning or training operations, such as unsupervised learning, weakly supervised learning, semi-supervised learning, or supervised learning. A machine learning model can be configured using training data from various domain-agnostic and/or domain-specific data sources. The training data can include a plurality of training data elements (e.g., training data instances). Each training data element can be arranged in structured or unstructured formats; for example, the training data element can include an example output mapped to an example input. The training data can include data that is not separated into input and output subsets (e.g., for configuring the machine learning model to perform clustering, classification, or other unsupervised machine learning operations). The training data can include human-labeled information, including but not limited to feedback regarding outputs of the machine learning model, which can allow the machine learning model to generate more human-like outputs.

Referring back to FIG. 2A, a block diagram of an example system using supervised learning is shown. Supervised learning is a method of training a machine learning model given input-output pairs. An input-output pair is an input with an associated known output (e.g., an expected output).

Machine learning model 204 may be trained on known input-output pairs such that the machine learning model 204 can learn how to predict known outputs given known inputs. Once the machine learning model 204 has learned how to predict known input-output pairs, the machine learning model 204 can operate on unknown inputs to predict an output.

The machine learning model 204 may be trained based on general data and/or granular data (e.g., data based on a specific user 132) such that the machine learning model 204 may be trained specific to a particular user 132.

Training inputs 202 and actual outputs 210 may be provided to the machine learning model 204. Training inputs 202 may include features such as numerical data, categorical variables, text, images, audio signals, and the like.

The inputs 202 and actual outputs 210 may be received from various data repositories. For example, a data repository may contain labeled datasets with example data points and their corresponding correct outputs. The data repository may also contain data associated with specific users or general populations. Thus, the machine learning model 204 may be trained to predict outcomes based on the training inputs 202 and actual outputs 210 used to train the machine learning model 204.

The example system may include one or more machine learning models 204. In an embodiment, a first machine learning model 204 may be trained to predict data using a classification or regression technique. For example, the first machine learning model 204 may use the training inputs 202 to predict outputs 206 by applying the current state of the first machine learning model 204 to the training inputs 202. The comparator 208 may compare the predicted outputs 206 to actual outputs 210 to determine an amount of error or differences. For example, the predicted output 206 may be compared to the actual output 210 to calculate a loss function or error metric.

In other embodiments, a second machine learning model 204 may be trained to make one or more recommendations to the user 132 based on the predicted output from the first machine learning model 204. For example, the second machine learning model 204 may use the training inputs 202 and the predicted outputs from the first machine learning model 204 as its own input to predict outputs 206 in the form of personalized recommendations by applying the current state of the second machine learning model 204 to the training inputs 202. The comparator 208 may compare the predicted outputs 206 (e.g., the recommended actions or items) to actual outputs 210 (e.g., user choices or feedback on previous recommendations to determine an amount of error or differences.

The actual outputs 210 may be determined based on historic data of recommendations made to the user 132 and the resulting outcomes in the supply chain. In an illustrative non-limiting example, the machine learning model 204 may be continuously trained to improve its quality and accuracy in predicting and improving supply chain operations. The machine learning model 204 can take into account various inputs such as forecasted demand, inventory data, customer preferences, and distributor preferences to model, recommend, and execute operations. The actual outputs 210 may then be determined by measuring the real-world outcomes after implementing these recommendations, such as the resulting stockout rate, inventory carrying costs, and overall supply chain efficiency.

In some embodiments, a single machine learning model 204 may be trained to make one or more recommendations to the user 132 based on current user 132 data received from enterprise resources 128. That is, a single machine learning model may be trained using the training inputs 202, which include historical data and current user data, to predict outputs 206 in the form of personalized recommendations by applying the current state of the machine learning model 204 to the training inputs 202. The comparator 208 may compare the predicted outputs 206 to actual outputs 210 to determine an amount of error or differences. The actual outputs 210 may be determined based on historic data associated with the recommendation to the user 132 and their subsequent actions or outcomes. The machine learning model 204 may use the data to learn patterns and make increasingly accurate recommendations over time. For instance, if the machine learning model 204 recommends ordering 1000 units of a product and a user 132 follows the recommendation, the actual output 210 may include data on whether the quantity was sufficient, excessive, or inadequate based on subsequent demand and inventory levels. This feedback loop can allow the machine learning model 204 to continuously refine its predictions and adapt to changing conditions and user preferences in the supply chain ecosystem.

During training, the error (represented by error signal 212) determined by the comparator 208 may be used to adjust the weights in the machine learning model 204 such that the machine learning model 204 changes (or learns) over time. The machine learning model 204 may be trained using a backpropagation algorithm, for instance. The backpropagation algorithm operates by propagating the error signal 212. The error signal 212 may be calculated each iteration (e.g., each pair of training inputs 202 and associated actual outputs 210), batch and/or epoch, and propagated through the algorithmic weights in the machine learning model 204 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 204 may be tuned to reduce the amount of error, thereby minimizing the differences between (or otherwise converging) the predicted output 206 and the actual output 210. The machine learning model 204 may be trained until the error determined at the comparator 208 is within a certain threshold (or a threshold number of batches, epochs, or iterations have been reached). The trained machine learning model 204 and associated weighting coefficients may subsequently be stored in memory 116 or other data repository (e.g., a database) such that the machine learning model 204 may be employed on unknown data (e.g., not training inputs 202). Once trained and validated, the machine learning model 204 may be employed during a testing (or an inference) phase. During testing, the machine learning model 204 may ingest unknown data to predict future data (e.g., future demand, inventory levels, supplier performance, delivery times, and the like).

Referring to FIG. 2B, a block diagram of a simplified neural network model 200B is shown. The neural network model 200B may include a stack of distinct layers (vertically oriented) that transform a variable number of inputs 214 being ingested by an input layer 216 into an output 218 at the output layer 220.

The neural network model 200B may include a number of hidden layers 222 between the input layer 216 and output layer 220. Each hidden layer has a respective number of nodes (224, 226, and 228). In the neural network model 200B, the first hidden layer 222-1 has nodes 224, and the second hidden layer 222-2 has nodes 226. The nodes 224 and 226 perform a particular computation and are interconnected to the nodes of adjacent layers (e.g., nodes 224 in the first hidden layer 222-1 are connected to nodes 226 in a second hidden layer 222-2, and nodes 226 in the second hidden layer 222-2 are connected to nodes 228 in the output layer 220). Each of the nodes (224, 226, and 228) sum up the values from adjacent nodes and apply an activation function, allowing the neural network model 200B to detect nonlinear patterns in the inputs 214. Each of the nodes (224, 226, and 228) are interconnected by weights 230-1, 230-2, 230-3, 230-4, 230-5, 230-6 (collectively referred to as weights 230). Weights 230 are tuned during training to adjust the strength of the node. The adjustment of the strength of the node facilitates the neural network’s ability to predict an accurate output 218.

In some embodiments, the output 218 may be one or more numbers. For example, output 218 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As such, the softmax classifier may be employed because of the classifier’s ability to classify various classes. Other classifiers may be used to make other classifications. For example, the sigmoid function makes binary determinations about the classification of one class (i.e., the output may be classified using label A or the output may not be classified using label A).

In some embodiments, the neural network models described herein can comprise transformer based architectures configured as large language models (LLMs). A transformer model can process sequential input data (e.g., tokenized natural language text, code sequences, time series) using stacked self attention and feed forward layers. Each self attention layer computes contextualized representations of inputs 214 by weighting the relationships between all token positions in the sequence, aiding the model to capture short and long range dependencies, which may exceed fixed window constraints. The transformer may include separate encoder and decoder stacks, only an encoder stack (e.g., BERT style), or only a decoder stack (e.g., GPT style), with learned positional encodings injected into layer inputs to preserve ordering information. Multi head attention mechanisms aid the model to jointly focus on information from different representation subspaces at different positions.

A large language model can be obtained by instantiating a transformer architecture with a large number of layers 222, nodes 224, and attention heads, and training it on very large corpora (potentially hundreds of billions of tokens) drawn from domain agnostic sources (e.g., general web text) and/or domain specific corpora (e.g., industry specific documentation, proprietary datasets). Training objectives may include autoregressive next token prediction, masked language modeling, sequence to sequence translation, or combinations thereof, optimized using stochastic gradient descent or related algorithms. During training, the model parameters (weights 230, biases, layer norms) are iteratively updated to minimize a loss function measuring the divergence between predicted token probabilities and actual tokens. Once trained, the LLM can be adapted to downstream tasks via supervised fine tuning, reinforcement learning from human feedback, prompt engineering, or other conditioning mechanisms, enabling it to generate coherent text, summarize content, answer questions, classify sequences, generate source code, or perform other generative or discriminative natural language understanding tasks. In deployment, an LLM ingests a sequence of inputs 214 (e.g., tokens), maps them through learned embedding matrices into dense vector representations, applies a series of attention and feed forward transformations across one or more hidden layers 222 and nodes 224 to produce updated context aware vectors, and projects these to an output 218 of a distribution over a vocabulary space via an output layer 220 layer (e.g., softmax function). Decoding strategies such as greedy search, beam search, top k sampling, or nucleus (top p) sampling may be applied to select output tokens iteratively when generating sequences.

Transformer architectures and large language models as described herein can be extended beyond natural language text to operate as multimodal models that process and integrate information from different input types of content items, such as images, audio waveforms, video frames, tabular data, and sensor signals, in addition to or in place of textual inputs 214. In such cases, various embedding modules can convert each modality into a unified dense representation space, which can then be jointly processed through shared hidden layers 222 and nodes 224, with modality specific or cross modal attention mechanisms aiding the model to learn correlations between heterogeneous data sources to identify divergence or correlation between content items and one or more references. Outputs from the output layer 220 can likewise represent multiple modalities, for example generating descriptive natural language output 218 from image features, predicting labels from audio inputs, or producing synchronized text and image sequences, thereby supporting a wide range of cross modal and multimodal applications.

### C. Intelligent Content Evaluation Tool

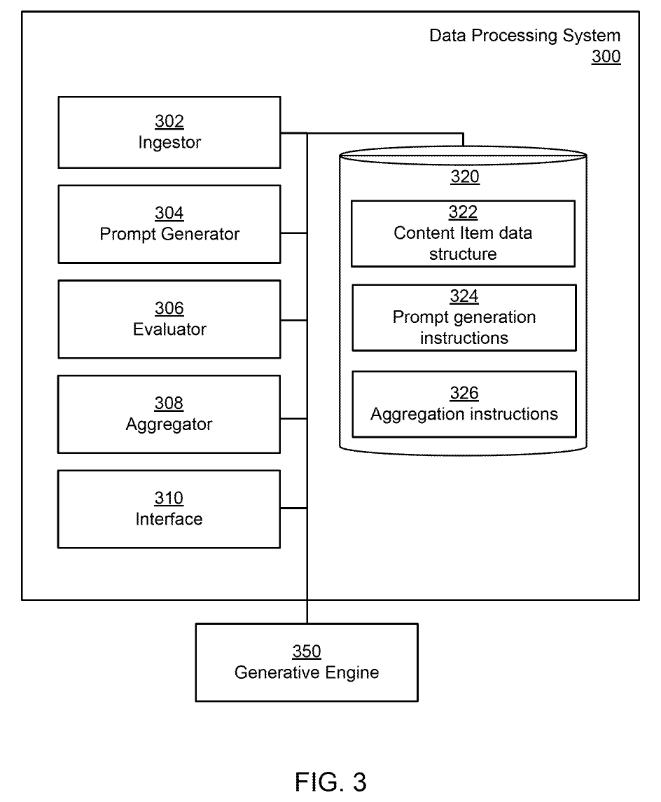

As shown in FIG. 3, a data processing system 300 includes or interfaces with an ingestion engine of an ingestor 302 to receive content items from a data repository. The data processing system 300 includes or interfaces with a prompt generator 304 to generate prompts for various content items. The data processing system 300 includes or interfaces with an evaluation agent of an evaluator 306 to provide the prompts to an LLM. The data processing system 300 includes or interfaces with an aggregator 308 to aggregate responses to prompts for various combinations of the content items. The data processing system 300 includes or interfaces with an interface 310 to exchange information with one or more data sources or sinks, as can include a graphical or other user interface to exchange information with a user. The data processing system 300 includes a data repository 320 to exchange and store data with or between the various components of the data processing system 300.

The ingestor 302, prompt generator 304, evaluator 306, aggregator 308, or user interface 310 can each include or interface with at least one processing unit or other logic device such as a programmable logic array engine, or module configured to communicate with a data repository 320 or database. The ingestor 302, prompt generator 304, evaluator 306, aggregator 308, or user interface 310 can be separate components, a single component, or part of the data processing system 300. The data processing system 300 and various components thereof can include hardware elements, such as one or more processors, logic devices, or circuits. For example, the data processing system 300 can include one or more components or structures of functionality of computing devices depicted in FIG. 1A.

The data repository 320 can include one or more local or distributed databases, and can include a database management system. The data repository 320 can include computer data storage or memory and can store one or more of content item data structures 322, prompt generation instructions 324, aggregation instructions 326.

The content item data structure 322 can refer to or include a data structure including various content items. Content items can include textual or other content, such as image content, video content, audio content, and so forth. Some examples of content items include digital advertisements, web page compositions, or video content, and so forth. In some embodiments, the data structure 322 is provided as a data lake including content items received from various sources, wherein the content items can be provided according to a file location, unique identifier, or column header. In some embodiments, the content item data structure 322 is provided as a digital asset management system (DAM), content management system (CMS), or other data store configured to organize, and provide access to content items, associated metadata, and usage information for subsequent retrieval, processing, and presentation. In some embodiments, the content item data structure 322 is provided as another enterprise resource, such as a public or private website, a document management system, or so forth.

The content item data structure 322 can be organized according to a hierarchical structure wherein various content items maintain a parent-child relationship (e.g., a file directory) or flat structure, which can include or omit indicia of relationships between content items (e.g., tags or metadata descriptors). In some embodiments, the content item data structure 322 can include indications of use, as can include frequency of use, recency of use, time of access, audience use, or so forth.

The prompt generation instructions 324 can refer to or include a structured sequence of executable operations configured to assemble prompts in accordance with one or more predefined generation rules. These operations can be expressed as a set of deterministic instruction blocks, conditional branches, and iterative control flows that, when executed by the prompt generator 304, construct prompt objects or text strings tailored for a given criteria category and content item. The prompt generation instructions 324 can specify the incorporation of category-specific evaluation data, such as textual descriptions, exemplar media, target scoring scales, and formatting templates, into the resulting prompt. The instructions can further define alternative prompt formats depending on detected content type (e.g., text, image, video), intended audience persona, or brand segment, and can include reusable subroutines for embedding metadata, context statements, or criteria-specific guidance within the prompt body.

The prompt generation instructions 324 can generate a prompt configured to elicit a quantitative score for conformance to one or more selected criteria categories (e.g., a score for each of the criteria categories). The prompt generation instructions 324 can generate a prompt configured to elicit a qualitative explanation for the generated score, such that an explanation of alignment or deviation can be provided. The prompts to generate the quantitative scores and qualitative explanations can be provided as a same or separate prompts.

The aggregation instructions 326 can refer to or include instructions configured to generate an aggregate representation of evaluation results across multiple content items or categories. These instructions can define procedures for computing composite quantitative scores from individual item-level scores, such as averaging, median calculation, weighted summation, or other statistical measures based on prominence or usage metrics. The aggregation instructions 326 can also specify logic for synthesizing qualitative explanations into higher-level summaries, identifying recurring patterns, common non-conformances, or clusters of related issues. In some embodiments, the aggregation instructions 326 can provide rules for partitioning aggregation by hierarchical structures (e.g., folder, website section, campaign grouping) and for applying weights that differentiate the influence of particular content types or high-value assets.

The data processing system 300 can include or interface with at least one ingestor 302 to receive content items from one or more data sources of a data repository 320. In some embodiments, the ingestor 302 can receive a content item data structure 322 including indices for various content items organized according to a predefined structure. For example, the ingestor 302 can receive the content items from a digital asset management system (DAM) or content management system (CMS). In some embodiments, the ingestor 302 can index data from one or more storage locations. For example, the ingestor 302 can be configured to scrape an internal or external facing website, file structure, data lake, or other data store.

The content items received by the ingestor 302 can be of varying content types. For example, the ingestor 302 can receive textual content, images, and animations (e.g., video, GIF files, sequenced images, or so forth). The content items can include composite or packaged documents that combine multiple content types and styling information (e.g., HTML with CSS and associated assets or PDFs). These packaged documents can preserve the layout, fonts, and embedded media of the textual content, images, or animations in a unified format for consistent rendering across different platforms. The ingestor 302 can ingest the unified format or subcomponents thereof as the content items. The ingestor 302 can be configured to index or classify the content into types based on data received from the storage location, or based on further classification techniques, as can include file type checking, embedded metadata, rule-based classification, or so forth. In some embodiments, the classifier can identify the content type based on multiple techniques. For example, a proof of a poster or post can include textual content stored in an image, wherein the ingestor 302 can identify the textual content according to identifiers in a received data structure, the application of an optical character recognition technique, or so forth.

The data processing system 300 can include or interface with at least one prompt generator 304 to dynamically construct prompts configured to determine conformance of each of various content items with one or more criteria categories. For example, the prompt generator can generate the dynamically constructed prompts according to deterministic instructions included in the prompt generation instructions 324.

The prompt generator 304 can generate the instructions based on one or more selected criteria categories. For example, the prompt generator 304 can, according to an execution of the prompt generation instructions 324, generate a prompt for an LLM to determine a conformance with various selected criteria categories. The prompt generator 304 can receive the selection of the one or more criteria categories from the interface 310. For example, the prompt generator 304 can receive the selection based on actuation of a control element presented to a user via a graphical or other user interface, or according to a further communicative connection of the interface 310 (e.g., a datalink between the data processing system 300 described herein and another computing device).

The prompt can include a prompt for a quantitative score of conformance on a content item basis for each of the content items. For example, the prompt can include an instruction to indicate a degree of conformance according to a predefined scale. The scale can extend between zero and one, one and five, one and ten, one and one-hundred, or so forth. The prompt can further be configured to cause a generative engine 350 to generate the score for each of the selected criteria categories. The prompt can include a prompt for a qualitative explanation of conformance on a content item basis. For example, the qualitative explanation can indicate a reason for a deviation from conformance to the selected criteria categories. The qualitative explanation can include an explanatory reason (e.g., “font does not match style guidelines”, “writing is unclear”, or “inconsistent with the approved visual or stylistic framework”). The qualitative explanation can include a recommendation to better align the content items with the guidelines (e.g., “replace Helvetica with approved Open Sans font”, “reframe text into active voice”, or “update image to match brand palette”). As for the quantitative scores, the prompt generator 304 can generate the qualitative explanations for each of any selected criteria categories, or for a combination thereof.

The data processing system 300 can include or interface with at least one evaluation agent of an evaluator 306 to cause a generative engine 350 to execute the prompts generated by the prompt generator 304. The evaluation agent can maintain an operative connection with one or more generative engines 350 to provide the prompts generated by the prompt generator 304 to the generative engines 350 (e.g., an LLM). Accordingly, the evaluation agent can maintain coherency between one or more content items and a prompt corresponding thereto, and provide the content items and corresponding prompt to the LLM or another generative engine 350.

The evaluator 306 can further manage the establishment, maintenance, or operation of the evaluation agent and the communicative connection with the generative engine 350. This maintenance can include maintaining a status of any prompts and content items to be provided to the generative engine 350 and implementation of retry logic upon detecting a loss of communication or operation of the generative engine 350, evaluation agent, or communicative connection therebetween. For example, the evaluator can re-instantiate an evaluation agent, re-establish communication with the generative engine 350, select a failover generative engine 350, or so forth.

The data processing system 300 can include or interface with at least one aggregator 308 to generate aggregate scores to indicate the conformance of groups of content items to the one or more criteria categories. The aggregate scores can include an aggregate quantitative score. For example, the aggregate quantitative score can include an average, median, z-score, weighted average, or other aggregation of the various quantitative scores. For hierarchical or other partitioned data structures, the aggregator 308 can generate the quantitative score for each level or partition of the data structure. The aggregation can include an aggregation for each criteria category, or across various selected criteria categories.

The aggregate scores can include an aggregate qualitative explanation. For example, the aggregate qualitative explanation can indicate an overall explanation for the deviation from conformance to the one or more criteria categories. As for the aggregate quantitative scores, the aggregate qualitative explanations can be provided for various hierarchical or other partitioned levels of the content item data structure 322.

The data processing system 300 can include or interface with at least one interface 310 to exchange information with a user or other data sources or sinks. For example, the interface 310 can include a user interface configured to interface with a user. In some embodiments, the interface 310 includes an operative connection with another data source configured to receive selections of criteria categories. Various elements of the information received by the data processing system 300 can be received by either of the user interface or other interface.

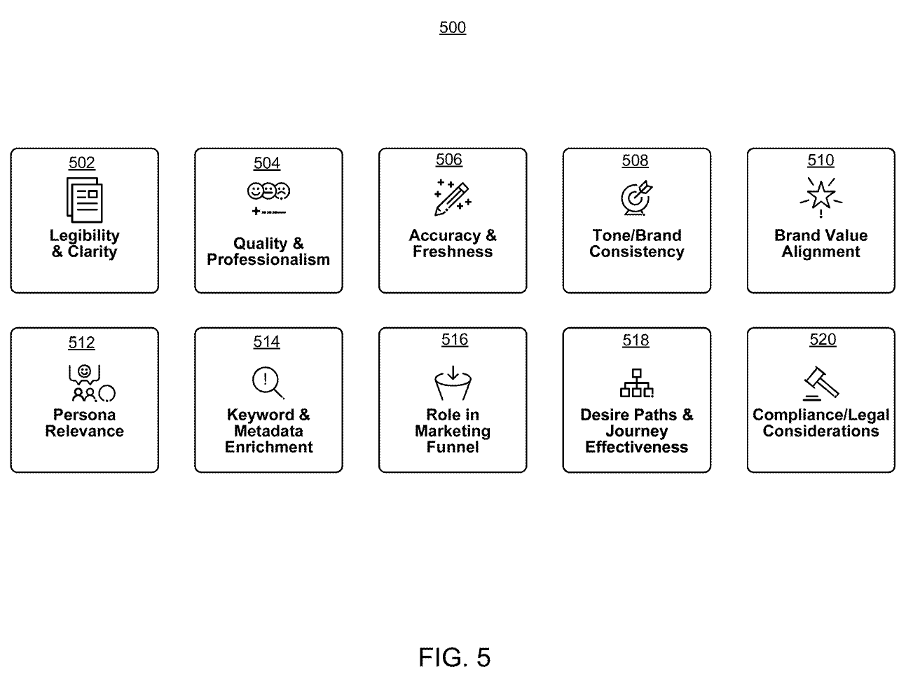

The criteria categories received by the data processing systems can include an identity, as well as various further descriptive information. For example, the criteria categories can include a category of clarity of writing, which can include metrics, descriptions, or other aspects of clarity of writing. Moreover, the criteria categories can vary between organizations, audiences, and so forth. For example, continuing the illustrative example of the clarity of writing criteria category, a first organization or audience can define clarity of writing to include broadly accessible writing, as may be useful for signage (e.g., not exceeding a fourth grade reading level, block lettering readable from a distance, and so forth). Another criteria category of clarity of writing for another audience can refer to, for example, accurate citations or references to figures. Some further examples of criteria categories are described with reference to FIG. 5.

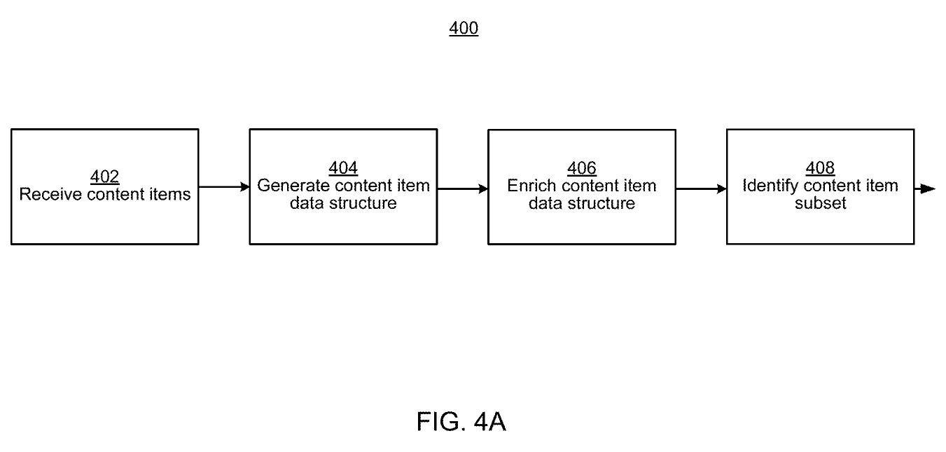

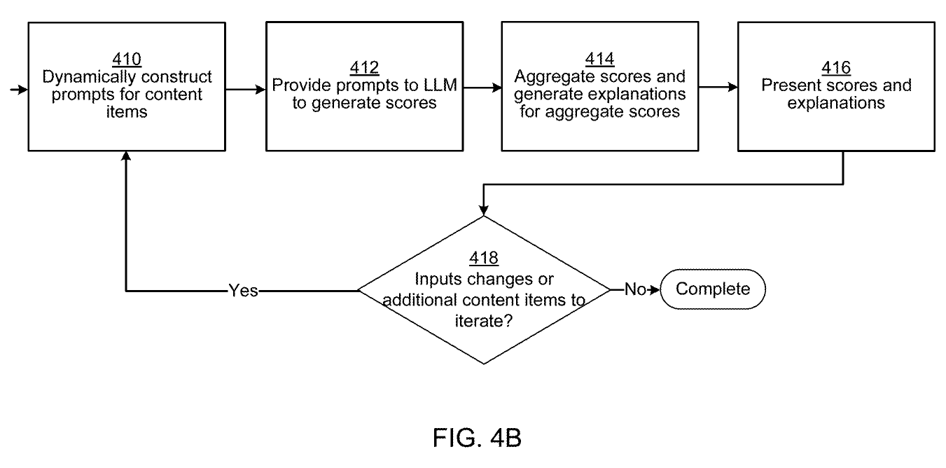

Referring to FIGS. 4A-4B, details of the design and operation of a method 400 for content evaluation are provided. At operation 402 of FIG. 4A, the ingestor 302 receives various content items. The ingestor 302 can receive the various content items according to a predefined structure of one or more content item data structures 322 or according to a non-structured form. For example, the ingestor 302 can execute a web scraping tool and analytics tool (e.g., screaming frog) to retrieve various content items from an in-situ source, and correlate indications of use with the content items.

At operation 404 of FIG. 4A, the ingestor 302 generates a content item data structure 322. For example, the ingestor 302 can normalize received content items. In some embodiments, the normalization can be provided according to a 1:n or n:1 mapping. For example, usage metrics for a website can be mapped to n content items present on a webpage, so that the various content items can map to a same uniform resource identifier. According to a format of one or more data sources for the content items, operation 404 can include additional or fewer operations suboperations. For example, where the content items are received from a single normalized source adhering to same data types as the prompt generator 304, various normalization operations can be omitted at operation 404.

At operation 406 of FIG. 4A, the ingestor 302 can enrich the content item data structure 322. The enrichment can include generation of metadata, index values, classifications (e.g., according to a file type or other indication of type). As discussed with regard to operation 404, some data sources can provide differing usage or other metadata such that some enrichment operations can be omitted where the data processing system determines that such information is present in a data source.

At operation 408 of FIG. 4A, the ingestor 302 can identify a subset of the content items. The selection can provide an initial or trial of operation for subsequent operations, to provide an opening to adjust prompts, criteria categories, or other aspects of the operation of the present method 400. In some embodiments, the selection of the subset of the content items is based on the enriched data of the normalized content item data structure 322. For example, to select the subset, the ingestor 302 can rank sort the enriched metadata (e.g., to select a most accessed, most recent (or oldest), or other subset). Moreover, the selection of the subset can reduce computational resources used to perform subsequent operations of the method 400. For example, the ingestor 302 can dynamically select a quantity of the subset based on available computer resources, as can satisfy a performance metric (e.g., for near-real time operation, or another threshold).

The selected subset can be organized according to various combinations of content items. For example, content items can be selected at a URL, folder, or other level including more than one atomic content item. In this way, relationships between individual content items can be evaluated in subsequent evaluations, as can refer to co-related data of a web page intended for display together (sometimes referred to as composite assets or layout grouping assemblages). Co-relations associated with the related content items can be received as metadata for the various associated images.

Referring now to operation of 410, FIG. 4B, the prompt generator 304 can dynamically construct a prompt to determine conformance of each of various content items with each of the various criteria categories. The prompt can be configured to elicit a quantitative score from a generative engine 350. The prompt can be configured to elicit a qualitative explanation of the quantitative score from the generative engine 350. The content items can be accessed according to a content data item structure generated or otherwise accessible to the ingestor 302, and the criteria categories can be selected by, and include evaluation criteria data as received by the interface 310. The evaluation criteria data can include rules, guidelines, enumerated lists, sample content items, and so forth. To generate the prompts, the prompt generator 304 can execute deterministic instructions of the prompt generation instructions 324. For example, the prompt generation instructions 324 can include a nested structure of a scripting language or other programmatic instructions to cause the prompt generator 304 to loop through instructions to construct the prompts for each of the content items.

In some embodiments, the prompt generation instructions 324 include instructions to generate the prompt based on a content type. For example, writing style guidelines can be applied to textual content, but not to images or videos. Similarly, the prompt generation instructions 324 can include instructions to apply different style guidelines to black and white images and color images, or images and video. Moreover, the content type can refer to further content types. Types may differ between a publicly facing internet site and an intranet site, audience intended for different audiences (sometimes referred to as personas, as can include geographic-based regions, age-based demographics, sub-brands or other segmentations, and so forth). The prompt generator 304 can provide the prompts, along with an identity of the corresponding content items (e.g., an index number or other identifier) to the evaluator 306.

Referring now to operation of 412 of FIG. 4B, the evaluator 306 can provide the prompts generated by the prompt generator 304 to a generative engine 350, such as an LLM. Provision of the prompt and content items can cause the generative engine 350 to generate a quantitative score for the conformance and a qualitative explanation for the quantitative score. For example, the prompts can be provided as one or more iterative exchange with the LLM (e.g., a first iteration for a quantitative score and a subsequent iteration for an explanation thereof, or a single pass to generate both of the quantitative score and the qualitative explanation). The evaluator 306 can present the output of the quantitative scores or qualitative explanations to the interface 310 (e.g., the user interface). Moreover, the evaluator 306 can provide the quantitative scores or qualitative explanations to the aggregator 308 for aggregation, as can further be presented as output to the interface 310. For example, the aggregated scores or aggregated qualitative explanations can be provided via a same or separate displays of a user interface.

Referring now to operation of 414 of FIG. 4B, the aggregator 308 can aggregate the quantitative scores or qualitative explanations of operation 412. For example, the aggregator 308 can combine (e.g., average) the various quantitative scores generated at operation 410 to generate an aggregate score for a category criteria. The aggregator 308 can generate the combined quantitative scores for one or more hierarchical levels, folders, directories, or other partitions of the content item data structure 322. In some embodiments, the combined quantitative scores can be weighted according to a prominence of the content items. The prominence of the content items can be based on metadata associated therewith. For example, more prominent content items can refer to or include content items provided in the root of a directory structure, home page of a website, or other location, relative to other of the content items. In some embodiments, the prominence can be determined based on a number of accesses, views, impressions, or other frequency of use data for the content items. For example, a content item accessed 40,000 times per month can be provided with a higher weighting than a content item accessed 400 times per month. In some embodiments, the generation of the aggregate quantitative scores can include aggregated scores for multiple (e.g., all selected) criteria categories.

Further, at operation 414, the aggregator 308 can generate aggregate qualitative explanations for one or more of the aggregate quantitative scores. For example, the qualitative explanations can include an indication of any outliers or other high contributors to the aggregate qualitative explanations. The qualitative explanations can include an explanation of the deviation of the content items, or recommendations to remove, add, or modify content items, or their prominence, to increase the conformance of the content items with any criteria categories. In some embodiments, the generation of the aggregate qualitative explanations can include aggregated explanations for multiple (e.g., all selected) criteria categories. For example, such an aggregated qualitative explanations can include recommendations for criteria categories exhibiting greatest deviation, or can omit recommendations which would result in offsetting changes to conformance (e.g., a recommended change that would increase persona affiliation but decrease writing clarity or conformance to branding guidelines).

At operation 416, the various quantitative scores and qualitative explanations (including aggregated or non-aggregated instances) are presented via the user interface. The interface can include control elements configured to adjust the criteria categories, the prompt generation instructions 324, or the aggregation instructions 326 based on the presented information. A user can actuate such control elements where, for example, the presented information can include erroneous indications of conformance or non-conformance to the criteria categories. For example, branding guidelines may be ingested improperly, or typographic errors may be present in the additional detail of the criteria categories, or the generative engine 350 can overfit based on certain instructions. For example, the generative engine 350 can, in response to an instruction to maintain a friendly and casual tone, indicate non-conformance based on appropriately punctuated or grammatically written language.

The interface 310 can include another control element to repeat operations 410-416 using the modified instances of the criteria categories, the prompt generation instructions 324, or the aggregation instructions 326, which can be iterated until receiving a satisfactory output. For example, at operation 418, the user processing system can receive an adjustment to the prompt generation instructions 324, the aggregation instructions 326, or the criteria categories, and return to operation 410. The user interface can include yet another control element to process further content items according to the modified or otherwise approved criteria categories, prompt generation instructions 324, or aggregation instructions 326, upon completion of which, a further presentation for the information can be provided according to the description of operation 416 and 418.

Some steps of the present method 400 can be omitted, repeated, or modified. For example, selection of the subset can be omitted and full results generated prior to iteration (e.g., for non-computationally constrained instances of the data processing system), iteration can be skipped (e.g., where initial results are satisfactory), or iterations can be repeated for various further subsets (e.g., a subset of 50, 500, 5000, then 500,000 content items). Moreover, the present method 400 can be performed on a content-item type basis, partition basis, or so forth.

Referring to FIG. 5, illustrative examples of criteria categories are provided, in accordance with some embodiments. For example, according to the depicted example, the criteria categories are provided according to the labels of clarity and legibility 502, quality and professionalism 504, accuracy and freshness 506, tone/brand consistency 508, brand value alignment 510, persona relevance 512, keyword and metadata enrichment 514, role in marketing funnel 516, desire path and journey effectiveness 518, and compliance and legal considerations 520. Although the labels of the criteria categories can be used for ease of reference, it should be understood that the criteria categories are not defined according to their labels alone. Each criteria category will further include additional detail according to evaluation criteria data. The evaluation criteria data can include a textual description, examples, reference templates, or so forth. Moreover, various organizations can employ different additional detail.

Each of the criteria categories can include additional detail according to a content item type. For example, for internally facing work instructions, the clarity and legibility 502 additional detail can include instructions to “Focus on whether each sentence communicates its meaning directly and unambiguously,” “Reward short, declarative sentences, consistent verb tense, and active voice,” and “Identify jargon, nested clauses, or undefined acronyms that could confuse a non-expert reader.” Conversely, for consumer brand marketing, instructions can include instructions to “Prioritize quick comprehension and natural flow on first read,” “Reward concise phrasing, logical sentence order, and visually scannable layout (short lines, limited subordinate clauses),” and “Flag overly dense text, mixed metaphors, or long words (> 3 syllables) that could slow a reader’s understanding.” Further, instructions can vary between short form textual content, videos, images, signage, or so forth.

The additional detail can vary according to an organization. For example, the additional detail for one organization can include instructions to use industry specific language to provide brief text based on presumed knowledge of industry standard terminology, and another organization can prioritize accessibility (e.g., no greater than a 4 th grade reading level).

In some embodiments, the data processing system 300 is configured to determine the additional detail of the criteria categories based on sample content. For example, the evaluator 306 can be configured to provide sample content items to the generative engine 350 to generate textual or other instructions for a criteria category. In some embodiments, the criteria category can include the sample content items. Such inclusion can avoid semantic drift between human or generative engine-generated descriptions (e.g., of tone/brand consistency 508 or brand value alignment 510) of those content items, and further outputs generated by the generative engine 350 based on the descriptions. For example, a multi-modal LLM can ingest branding guidelines including sample images which can provide increased compliance, relative to textual descriptions alone.

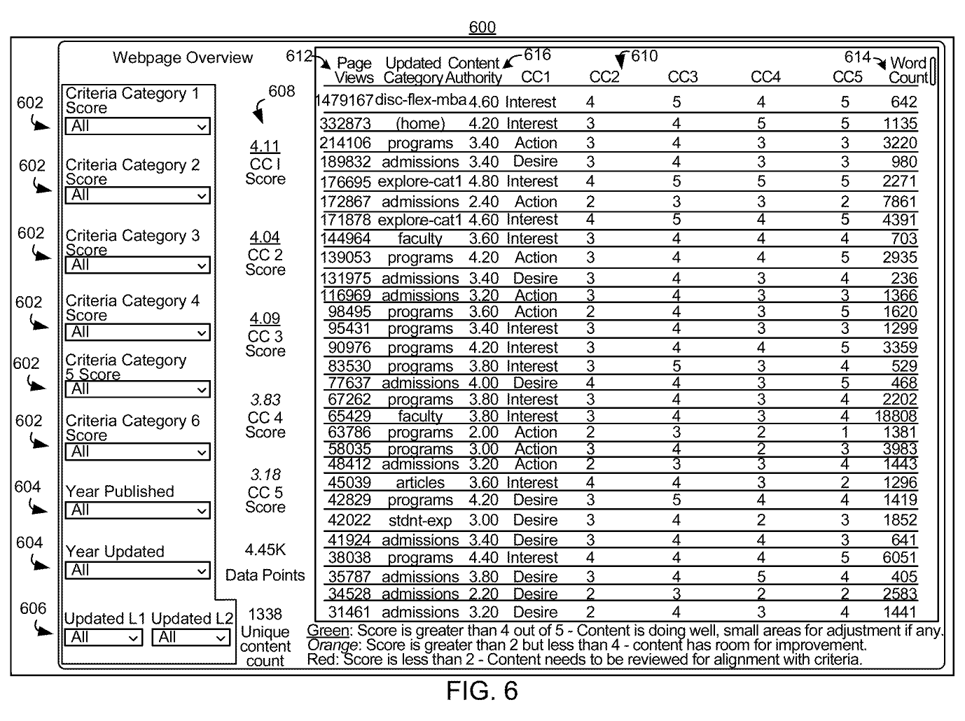

Referring to FIG. 6, an example of an GUI 600 instance of an output of the user interface 310 is provided, according to an illustrative embodiment of the present disclosure. The depicted example provides information for content items of a webpage. The user interface can include various control elements configured to filter output content items based on various criteria, as can include score thresholds, prominence, partitions of the content item data structure 322 or so forth. For example, according to the depicted illustrative example, first control elements 602 of a drop-down selection menu are provided to select a threshold score for each of various selected criteria categories. Second control elements 604 are provided to select content items based on temporal metadata associated with the content items, such as the depicted examples of a publish or upload year. Third control elements 606 are provided to select a hierarchical position of the webpage navigation level (e.g., a selected hierarchical level, or a level nested under the selected level). Further control elements can filter outputs according to any further metadata, classification, or other information enumerated or otherwise contemplated by the present application.

Other information of the depicted instance of the user interface 310 includes quantitative scores 608. More particularly, an aggregate quantitative score 608 is provided for each of the various selected criteria categories. The aggregate quantitative score 608 can refer to a score for all items, all items of a selected hierarchical level of a webpage (or other partition of a content item data structures 322), or according to any selected filter criteria (e.g., in response to an actuation of the various control elements). Content item level scores 610 are further provided for selected data content items. Various metadata items, such as the depicted example of frequency of access 612 and wordcount 614 are provided for the content items, though various further examples are contemplated, including other aspects of a prominence, audience, location, recency, or so forth. An aggregate score for each content item is provided (labeled as a content authority 616).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A system, comprising one or more processors coupled with memory, the system comprising:
an ingestion engine configured to receive, from a data repository, a plurality of content items;
an interface configured to receive a selection of a plurality of criteria categories to evaluate the plurality of content items and evaluation criteria data for each of the plurality of criteria categories;
a prompt generator configured to dynamically construct, for each of the plurality of criteria categories, a prompt to determine a quantitative score for conformance of each of the plurality of content items with each of the plurality of criteria categories, the prompt configured to instruct a large language model (LLM) to compare the evaluation criteria data against each of the plurality of content items;
an evaluation agent configured to receive the prompts from the prompt generator and cause the LLM to execute the prompts to generate, for each of the plurality of content items, the quantitative score for the conformance and a qualitative explanation for the quantitative score for the conformance of the plurality of content items against a corresponding one of the plurality of criteria categories;
an aggregator configured to determine, using the quantitative score of each of the plurality of content items, an aggregate quantitative score for each of the plurality of criteria categories and an aggregate qualitative explanation for each of the aggregate quantitative scores; and
a user interface configured to present a recommendation comprising at least the aggregate qualitative explanation and a plurality of quantitative scores of at least a subset of the plurality of content items.

2. The system of claim 1, wherein:
the plurality of content items comprise a plurality of content types, including text, images, and animations;
the LLM is a multi-modal LLM; and
the evaluation criteria data comprise separate instructions according to the plurality of content types.

3. The system of claim 1, wherein:
the data repository includes an indication of a prominence of one or more of the plurality of content items relative to other of the plurality of content items;
the aggregate quantitative score is weighted based on the prominence; and
the aggregate qualitative explanation is weighted based on the prominence.

4. The system of claim 3, wherein the indication of the prominence is based on:
a number of accesses of the one or more of the plurality of content items; and
a location of the one or more of the plurality of content items.

5. The system of claim 1, wherein the aggregate quantitative score and the aggregate qualitative explanation are weighted based on a content type, the content type comprising text, images, and animations.

6. The system of claim 1, wherein the data repository is a content management service for a website.

7. The system of claim 6, wherein the user interface is configured to present the quantitative scores for content items of a webpage of the website in response to receiving a selection of the webpage.

8. The system of claim 1, wherein the user interface is configured to present, in response to a selection of a node within a hierarchical data structure:
the quantitative scores associated with the node; and
an aggregate quantitative score for the node.

9. A method, comprising:
receiving, by one or more processors coupled with memory, a plurality of content items from a data repository;
receiving, by the one or more processors, a selection of a plurality of criteria categories to evaluate the plurality of content items and evaluation criteria data for each of the plurality of criteria categories;
dynamically constructing, by the one or more processors for each of the plurality of criteria categories, a prompt configured to determine a quantitative score for conformance of each of the plurality of content items with each of the plurality of criteria categories, the prompt configured to instruct a large language model (LLM) to compare the evaluation criteria data against each of the plurality of content items;
causing the LLM to execute the prompts to generate, for each of the plurality of content items, the quantitative score for the conformance and a qualitative explanation for the quantitative score for the conformance of the plurality of content items against a corresponding one of the plurality of criteria categories;
determining, by the one or more processors using the quantitative score of each of the plurality of content items, an aggregate quantitative score for each of the plurality of criteria categories and an aggregate qualitative explanation for each of the aggregate quantitative scores; and
presenting via a user interface, by the one or more processors, a recommendation comprising at least the aggregate qualitative explanation and a plurality of quantitative scores of at least a subset of the plurality of content items.

10. The method of claim 9, wherein:
the LLM is a multi-modal LLM; and
the evaluation criteria data comprise non-textual exemplar data.

11. The method of claim 9, wherein:
the data repository includes an indication of a prominence of one or more of the plurality of content items;
the aggregate quantitative score is weighted based on the prominence; or
the aggregate qualitative explanation is weighted based on the prominence.

12. The method of claim 11, wherein the indication of the prominence is based on:
a number of accesses of the one or more of the plurality of content items; or
a location of the one or more of the plurality of content items.

13. The method of claim 9, wherein the aggregate quantitative score or the aggregate qualitative explanation are weighted based on a content type, the content type comprising text, images, or animations.

14. The method of claim 9, wherein the data repository is a content management service for a website.

15. The method of claim 14, wherein the user interface is configured to present the quantitative scores for content items of a webpage of the website in response to receiving a selection of the webpage.

16. The method of claim 15, wherein the user interface is configured to present, in response to a selection of a node within a hierarchical data structure:
the quantitative scores associated with the node; and
an aggregate quantitative score for the node.

17. A computer-readable memory comprising instructions that, upon execution by one or more processors, cause the one or more processors to:
receive, from a data repository, a plurality of content items;
receive a selection of a plurality of criteria categories to evaluate the plurality of content items and evaluation criteria data for each of the plurality of criteria categories;
dynamically construct, for each of the plurality of criteria categories, a prompt to determine a quantitative score for conformance of each of the plurality of content items with each of the plurality of criteria categories, the prompt configured to instruct a large language model (LLM) to compare the evaluation criteria data against each of the plurality of content items;
cause the LLM to execute the prompts to generate, for each of the plurality of content items, the quantitative score for the conformance and a qualitative explanation for the quantitative score for the conformance of the plurality of content items against a corresponding one of the plurality of criteria categories;
determine, using the quantitative score of each of the plurality of content items, an aggregate quantitative score for each of the plurality of criteria categories and an aggregate qualitative explanation for each of the aggregate quantitative scores; and
present, via a user interface, a recommendation comprising at least the aggregate qualitative explanation and a plurality of quantitative scores of at least a subset of the plurality of content items.

18. The computer-readable memory of claim 17, wherein the evaluation criteria data comprise exemplar data.

19. The computer-readable memory of claim 18, wherein the exemplar data comprises textual, image, and video data.

20. The computer-readable memory of claim 17, wherein the aggregate quantitative score and the aggregate qualitative explanation are weighted based on a weighting assigned to each of the data content items.
